(19) United States
(12) Patent Application Publication
(10) Pub. No.: US 2002/0041102 A1
(43) Pub. Date: Apr. 11, 2002

(54) Robotic end effector for semiconductor wafer processing

(76) Inventors: Nis Krauskopf, Gloucester, MA (US); Dominic G. Pelletier, Groveland, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/902,496

(22) Filed: Jul. 10, 2001

Related U.S. Application Data
(60) Provisional application No. 60/217,173, filed on Jul. 10, 2000.

(51) Int. Cl. B25J 15/00

(52) U.S. Cl. 294/1.1

(57) ABSTRACT

Disclosed are robotic end effectors used for handling thin media such as semiconductor wafers during processing, including methods and apparatus for replaceably retaining a plurality of standoff pads in the end effectors.

### RELATED APPLICATIONS

This application is related to and claims priority to U.S. patent application Ser. No. 60/217,173 entitled “Robotic End Effector for Semiconductor Wafer Processing,” filed on Jul. 10, 2000, the disclosure of which is incorporated herein by reference in its entirety.

### TECHNICAL FIELD

The invention relates generally to the manufacture of robotic end effectors used for handling semiconductor wafers during processing and, more specifically, to methods and apparatus for retaining a plurality of standoff pads in the end effectors.

### BACKGROUND OF THE INVENTION

Pads used with robotic handling system end effectors used in the processing of semiconductor wafers provide improved supporting and/or gripping features on the surface of the end effector. The end effectors are used in robotic systems to handle and precisely position thin media, such as silicon wafers.

Current methods for installing the pads, which contact the wafer, involve inserting three conically tapered pads in mating holes in the end effector. The holes and pads are sized and configured so that a predetermined height of the smaller diameter portion of the pads extend through an upper face of the end effector.

A variety of methods may be employed to retain the pads in place. For example, disk-shaped parts, sometimes referred to as a backing plates, may be pressed into counterbores in the lower face of the end effector. The material around the counterbores can be swaged or peened to attempt to more securely retain the backing plates in place, which typically are made of dissimilar materials. Other methods of retention for the backing plate, also sometimes referred to as a retaining disc, include either being pressed into place in an interference fit in the end effector or being electron beam welded to the end effector.

Because the preferred materials for use as the pads and the end effectors generally are brittle, are not very compliant, and have high spring coefficients, thermal cycling tends to loosen the joints and thus the pads. Due to standoffs of the tips of the pads relative to the upper surface of the end effector being relatively small, on the order of about 0.003 inches to 0.015 inches, looseness can result in contact of the wafer with the surface of the end effector and result in damage or contamination of the wafer.

Other retention techniques considered involve using more compliant materials or different configurations, such as a collar between the end effector and the pad, though these pads still tend to loosen. Other methods can involve adhesives, welding, or other permanent joining methods that increase cost and eliminate the possibility of pad replacement. Further, the use of adhesives can result in contamination of the wafer when moving through hot processing areas, due to outgassing.

Edge gripping about the perimeter of the wafer requires that structural features protrude from the upper surface of the end effector to a sufficient height that at least tips of the protrusions extend above the wafer being gripped. This method also requires features to actuate the protrusions, extending and contracting them as required, which increases complexity and failure modes. Further, either the protrusion must be left as a remnant of a thicker piece of raw material than would otherwise be necessary, or the protrusions have to be attached to the end effector. The first method involves more raw material and machining. Also, these protrusions are not replaceable. The second method involves multiple parts and potentially complex permanent assembly methods, such as those discussed above. Edge gripping structures, however, can be expected to be relatively thick, and therefore difficult to maneuver through vertical stacking cassettes, where the wafers are stored, because to separation between cassette locations is on the order of only about 0.25 inches.

Other methods for installing pads that support wafers are multi-piece assemblies that require welding, bonding, or other installation techniques, such as riveting. In one method, a rivet-style stainless steel pad insertion method uses a ball bearing and a press to deform and enlarge a rear rim of the pad in a counterbore of the end effector to secure the pad. Pads installed using these methods cannot be removed easily or, in some cases, at all without damaging the end effector.

Accordingly, there is a need for a low profile end effector that can accommodate a wide variety of pad materials and reliably retain the pads in place, while permitting damaged or worn pads to be readily replaced.

### SUMMARY OF THE INVENTION

The present invention is drawn to an end effector for supporting thin media, such as a semiconductor wafer. The end effector employs an elastic beam located near a pad retention area. A pad is retained in the pad retention area by an elastic interference fit with a bore bounded at least in part by the elastic beam.

In one embodiment of the present invention, the pad retention area forms an aperture. In another embodiment of the present invention, the pad retention area further forms a counterbore.

In one embodiment of the present invention, the elastic beam has a cross-sectional area that varies along a length of the elastic beam. In another embodiment of the present invention, the elastic beam is configured so that elastic deformation loading is less that the yield strength of the elastic beam, both at room temperature and at typical elevated operating temperatures. In another embodiment of the present invention, the shape of the elastic beam can be generally linear, generally arcuate, and combinations thereof. In another embodiment of the present invention the material for the elastic beam can be stainless steel, aluminum, titanium, molybdenum, ceramics, composites, and combinations thereof. In yet another embodiment of the present invention, the elastic beam is formed in the end effector using either wire EDM, water jet, laser, milling or drilling methods.

The present invention is also drawn to the configuration of the pad. In one embodiment, the pad includes a thin media contacting surface and a first tapered section. In another embodiment of the present invention, the first tapered section also includes a maximum diameter portion disposed remotely from the media contacting surface and a minimum diameter portion disposed therebetween. In another embodiment of the present invention the pad includes a flange to keep the media contacting surface of the installed pad above the end effector. In another embodiment of the present invention, the pad includes a double tapered section. In another embodiment of the present invention, the first tapered section is a lead in contour of the double tapered section. In yet another embodiment of the present invention, the material for the pad can be stainless steel, quartz, ruby, sapphire, silicon carbide, silicon nitride, polymer materials, and tungsten carbide.

In yet another embodiment of the present invention, the end effector further includes a second elastic beam disposed proximate a second pad retention area to retain a second pad with an elastic interference fit. In yet another embodiment of the present invention, the end effector further includes a third elastic beam disposed proximate a third pad retention area to retain a third pad with an elastic interference fit.

### BRIEF DESCRIPTION OF THE DRAWINGS

The above and further advantages of this invention may be better understood by referring to the following description, taken in conjunction with the accompanying drawings in which;

FIG. 1 is a top view of elastically compliant arcuate beams forming a spiral pattern with a pad retention area according to one embodiment of the invention;

FIGS. 2A-2C are respectively top, side, and perspective views of a tapered pad according to one embodiment of the invention;

FIGS. 3A-3B are side and top views of a double tapered pad according to another embodiment of the invention;

FIGS. 4A-4B are side and top views of another double tapered pad similar to that shown in FIGS. 3A-3B, but with an enlarged diameter flange;

FIG. 5 is a perspective view of a tapered pad installed in a pad retention area between elastically compliant arcuate beams forming a spiral pattern;

FIG. 6A is a top view of three pads installed in an end effector, each pad adjacent to a single elastically compliant substantially linear beam forming a pad retention area;

FIG. 6B is a top view of three pads installed in an end effector, each pad nested between a pair of elastically compliant substantially linear beams forming a pad retention area;

FIG. 7 is an enlarged top view of an elastically compliant substantially linear beam forming a pad retention area in an end effector, illustrating a three point contact and bottom flange for retaining and positioning a pad in the pad retention area;

FIG. 8 is an enlarged top perspective view of an elastically compliant substantially linear beam forming a pad retention area in an end effector illustrating a bottom flange for axially supporting a pad;

FIG. 9 is bottom perspective view of the elastically compliant substantially linear beam forming a pad retention area in an end effector shown in FIG. 8, which includes a bottom counterbore;

FIG. 10 is a bottom perspective view of a double tapered pad installed proximate an elastically compliant substantially linear beam in an end effector which illustrates three point contact on the upper tapered pad surface for pulling the pad into the pad retention area;

FIG. 11 is a top view of an elastically compliant substantially linear beam forming an aperture in an end effector which illustrates an interference fit of a pad when installed;

FIG. 12A is a top view of an alternative configuration end effector having three tapered pads, each installed between a pair of elastically compliant substantially linear beams forming respective pad retention areas therebetween;

FIG. 12B is an enlarged cross-sectional view of a detail of the dual beam end effector of FIG. 12A taken along line A-A detailing a fully tapered installed pad with a partially recessed top flange;

FIG. 13 is a perspective view of the end effector of FIG. 12A;

FIG. 14 is an enlarged detail view of a tip of the end effector of FIG. 12A, without a pad installed; and

FIG. 15 is an enlarged detail view of the tip of the end effector in FIG. 12A depicting minimum, nominal, and maximum pad diameters accommodated.

### DETAILED DESCRIPTION

The present invention provides improved supporting and/or gripping features on the surface of an end effector used in robotic systems to handle thin media such as silicon wafers. In one embodiment, the end effector can be used with a robotic system to transport substrates around a cluster chamber tool having multiple processing areas. Edge retaining can also be accomplished by using a pad retained in accordance with this invention and differs from bottom surface support configurations in that the wafer is constrained from sliding off the end effector by a tapered, cylindrical, stepped, or otherwise shaped pad to allow the wafer to be placed between or on the pads, such that the wafer will not slip off of or move on the pads when the end effector is being accelerated or decelerated rapidly by the robot.

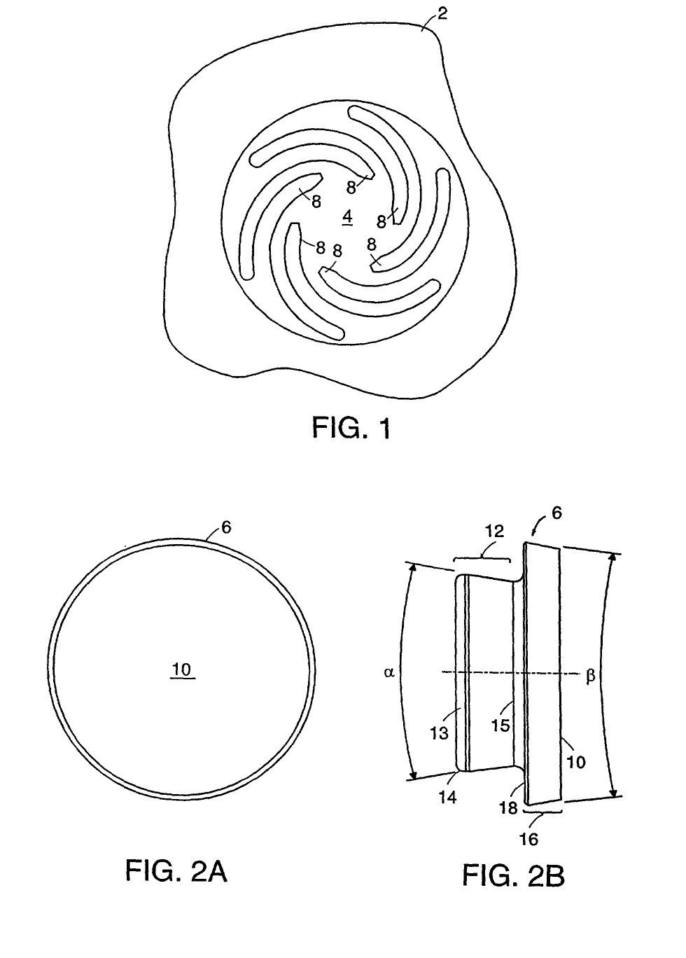

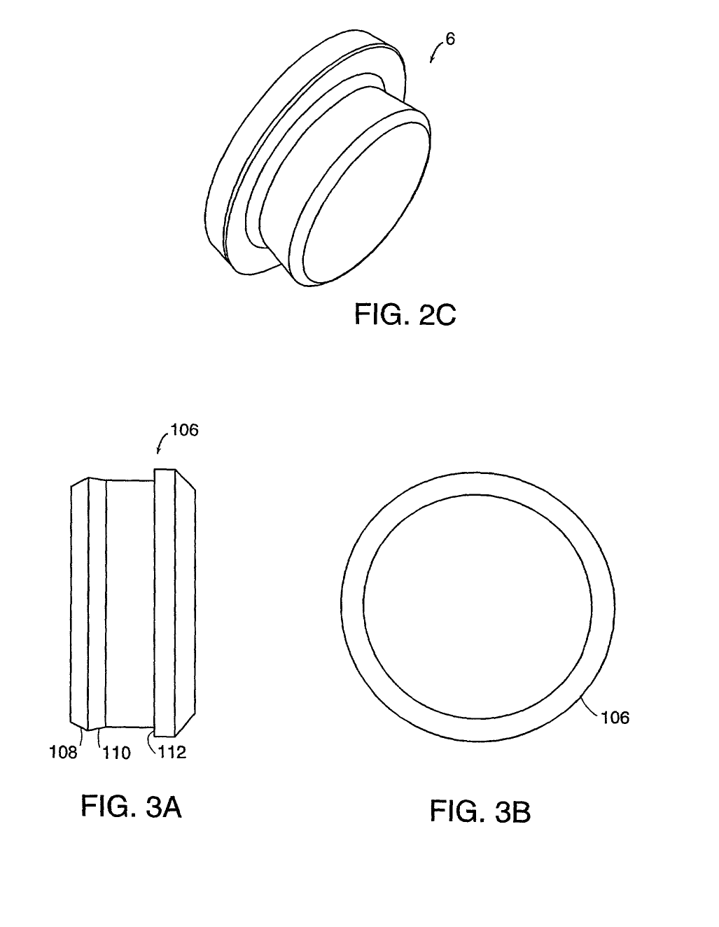

FIG. 1 illustrates a portion of an end effector 2 used for transporting semiconductor wafers substrates when the substrates are being processed. The end effector 2 has a pad retention area 4 for supporting a pad 6, such as that shown in FIG. 2B. In one embodiment, the pad retention area 4 can be a through hole or an aperture and, in another embodiment, the pad retention area 4 can be a partial bore. The pad 6 is used to support the substrate and keep the substrate from contacting the surface of the end effector 2. By preventing the substrate from contacting the surface of the end effector 2, the substrate is protected from contamination by the end effector 2 during substrate handling.

The pad 6 is installed into and retained by the end effector 2 by forming an elastic interference fit with at least one elastically compliant beam 8 proximate the pad retention area 4. The elastic beam 8 can be made locally thinner than the rest of the end effector 2. For example, in one embodiment, the elastic beam 8 can be made thinner than the rest of the end effector 2 by using one or more counter bores. The local elastic beam thickness is selected to enable the elastic beam 8 to engage the pad 6 without fracturing or breaking either, even when the elastic beam 8 and/or the pad 6 are made of relatively brittle materials. The elastic beam 8 thickness, width, length, and configuration can be selected to hold the pad 6 in place solely by friction. The diametrical interference between the pad retention area 4 formed by the elastic beam 8 and the pad 6 can be selected based on the amount of force desired to hold the pin 6 in place and the Young's modulus of the elastic beam material. The elastic beam 8 is designed so that the stress in the beam 8, when the pad 6 is installed, is less than the yield strength of the elastic beam 8 at temperatures encountered during substrate processing, which typically can range up to about 750° C. or higher.

The end effector 2 can be made of any suitable material. Desirable characteristics include low weight and structural stability at high temperature. Typical materials include metals, such as stainless steel, aluminum, titanium, molybdenum, ceramics, composites and combinations thereof. The end effector 2 can be manufactured from machined plate stock or can be pressed powder materials. Because the invention does not require bonding or otherwise attaching the pad 6 to the end effector 2, any combination of pad material and end effector material can be used. Also, because the pads 6 can be readily removed and replaced, worn or damaged pads 6 can be changed quickly, without rework of or damage to the end effector 2.

The elastic beams 8 can be of any shape such as generally linear, generally arcuate, and combinations thereof. The beams 8 can have tips configured to contact the pad 6 at a single axially disposed line or to nest the pad along a portion of a circumference thereof. The elastic beams 8 and pad retention area 4 can be made in the end effector 2 by wire EDM, water jet, laser, milling, drilling, or any other process known to those skilled in the art for producing the desired features in the material selected. The flexibility of the elastic beams 8 allows the pad 6 to be replaced readily, even when the end effector 2 is still mounted to the robotic system.

The elastic beams 8 formed in the end effector 2 are designed based upon the properties of the material being used in order to provide a desired retention force, while ensuring operation in the elastic region, at temperature. The size, shape, orientation, and configuration of the elastic beams 8 can be designed in a variety of ways, as long as the yield point for the material employed is not exceeded. The elastic beams 8 can have a cross-section which is square, rectangular, trapezoidal, arcuate, cylindrical, or any combination thereof. The elastic beams 8 can be tapered in width and/or thickness. The cross-section and moment of inertia for the elastic beams 8 can vary along a length of the elastic beams 8. In addition, the elastic beams 8 and/or the entire end effector 2 can be heat treated to change the properties of the elastic beams 8. For a given material, one embodiment of an end effector may employ relatively long, straight, thick elastic beams while another may employ shorter, thinner elastic beams.

According to another embodiment of the invention, the same pad size and configuration can be accommodated in a variety of end effectors manufactured of different materials by scaling the geometry of the pad retention area and elastic beam configuration to adjust for material property differences. Accordingly, less compliant, more brittle materials than conventionally employed can be used for manufacturing the end effectors.

The particular design of the complaint elastic beams 8 is related to the following parameters: the Young's modulus (E) of the end effector 2 material, the yield strength of the material (σ), thickness (t), width, and length of the elastic beam 8. The maximum thickness is set typically by stiffness requirements of the whole end effector 2. Based on the pad 6 material to be used, a retaining force (F) is determined. This value may be limited by the installation force required, the coefficient of friction between the pad 6 and end effector 2 material, the weight of the wafer to be handled, and other relevant factors considered by those skilled in the art. Space limitations may be of concern when beam deflection (d), flexure width (w), and flexure length (l) are chosen.

Using standard equations for beam deflection and stress, the sizing of the beam can be determined. Herein, I is the Moment of Inertia. For a rectangular cross-section beam:

$$I = \frac{t \cdot {w}^{3}}{12} \qquad ( 1 )$$

$$d = \frac{F \cdot {l}^{3}}{3 EI} \qquad ( 2 )$$

from equations (1) and (2)→(3)

$$w = \sqrt[3]{\frac{F \cdot {l}^{3} \cdot 4}{E \cdot d \cdot t}} \qquad ( 3 )$$

The length and width of the elastic beam 8 should be chosen such that only linear elastic deformation occurs. This can be verified by checking the maximum stress in the attachment area between the beam and the end effector, where the maximum bending moment (M) shown in equation (4) occurs. Further, using equations (5), (6), (7) and (8) for a rectangular beam, equation (9) is derived. Substituting equation (1) into equation (9) results in final stress equation (10) for a rectangular beam, as follows:

$$\begin{matrix}M = F \cdot l & ( 4 ) \\ σ = \frac{M c}{I} & ( 5 ) \\ σ = \frac{M}{W} & ( 6 )\end{matrix}$$

occurs. With equation (4) in

$$\begin{matrix}c = \frac{w}{2} \\ and & ( 7 ) \\ W = \frac{2 \cdot I}{w} & ( 8 )\end{matrix}$$

for a rectangular

beam follows→

$$σ = \frac{F \cdot l \cdot w}{2 \cdot I} \qquad ( 9 )$$

Therefore, for a rectangular beam (1) and (9)→(10)

$$σ = \frac{6 \cdot F \cdot l}{t \cdot {w}^{2}} \qquad ( 10 )$$

σ and E are specific to the materials used and may be obtained from material data sheets or empirically. Naturally, standard equations for beam deflection and stress for beams of alternate configurations can be used to ensure the beams are properly sized to ensure operation in the elastic range with margin.

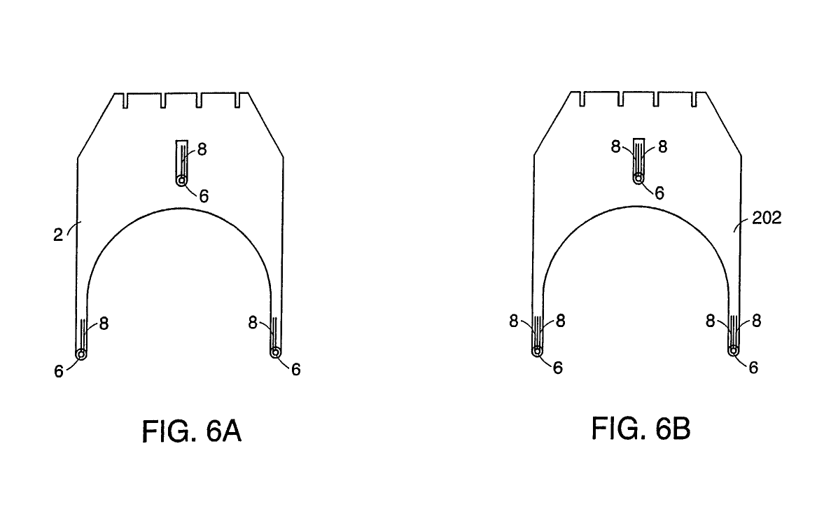

As an example, the formulas provided hereinabove are used to calculate the maximum stress in the elastic beams designed and shown in FIGS. 6A, 7, 8 and 9, as follows:

Young's Modulus of the end effector material, Molybdenum:

$$E = 320000 \frac{N}{{mm}^{2}}$$

Ref. [I]; end effector thickness: t=2.286 mm;

the retaining force: F=2N;

deflection: d=0.05 mm;

the flexure length chosen to be: l=22 mm.

The required flexure member width is calculated in accordance with equation (3):

$$w = \sqrt[3]{\frac{2 N \cdot {22}^{3} {mm}^{3} \cdot 4}{320000 \frac{N}{{mm}^{2}} \cdot 0.05 mm \cdot 2.286 mm}} = 1.32 mm \qquad ( 3 )$$

The maximum stress is determined by equation (10):

$$σ = \frac{6 \cdot 2 N \cdot 22 mm}{2.286 mm \cdot {1.32}^{2} {mm}^{2}} = 66.3 \frac{N}{{mm}^{2}} \qquad ( 10 )$$

This value is significantly less than Yield Strength of the Molybdenum material of:

$$σ = 580 \frac{N}{{mm}^{2}}$$

Ref [I]. The safety factor herein is 8.75, as calculated by dividing

the yield strength of 580 N/mm² by the maximum calculated stress 66.3 N/mm².

[I] from: PANSEE Aktiengesellschaft, A-6600 Reutte/Tirol, Austria, Publication “Molybdenum”, January 1997, table page 17.

The effects of elevated temperature on yield strength are well known and can be used to determine the reduction in yield strength and associated safety factor. Safety factors in the range of about two to ten or more are contemplated.

Referring to FIGS. 2A-2B, the pad 6 includes a media contact surface 10 and a first tapered section 12, having an included taper angle α. In a preferred embodiment, the taper angle α ranges from about 0 degrees to 45 degrees. In a more preferred embodiment, the taper angle α ranges from about 10 degrees to 30 degrees. In a most preferred embodiment, the taper angle α is about 20 degrees. The tapered section 12 includes a maximum diameter area 13 disposed remotely from the media contact surface 10, and a minimum diameter area 15 is disposed therebetween. The first tapered section 12 may include a lead in radius or bevel 14 for facilitating inserting the pad 6 into the pad retention area 4.

The pad 6 optionally also includes a second tapered area 16. In one embodiment, the second tapered section 16 has a taper angle β. In a preferred embodiment, the taper angle β ranges from about 0 degrees to 45 degrees. In a more preferred embodiment, the taper angle β ranges from about 10 degrees to 30 degrees. In a most preferred embodiment, the taper angle β is about 20 degrees. The second tapered section 16 can be configured with a predetermined height to prevent a semiconductor wafer from contacting the end effector 2. The second tapered section includes a flange surface 18 for abutting the end effector 2 or a counterbore formed therein. FIG. 2C is a perspective view of the tapered pad 6.

FIGS. 3A and 3B illustrate a side and top view of a double tapered pad 106. The first taper 108 forms a lead in chamfer to facilitate insertion into the end effector 2. The second taper 110 provides a surface for engaging the elastic beam(s) 8 to pull the pad 106 into the pad retention area 4 and positively seat the flange 112 of the pad 106 when the pad 106 is fully inserted into the end effector 2.

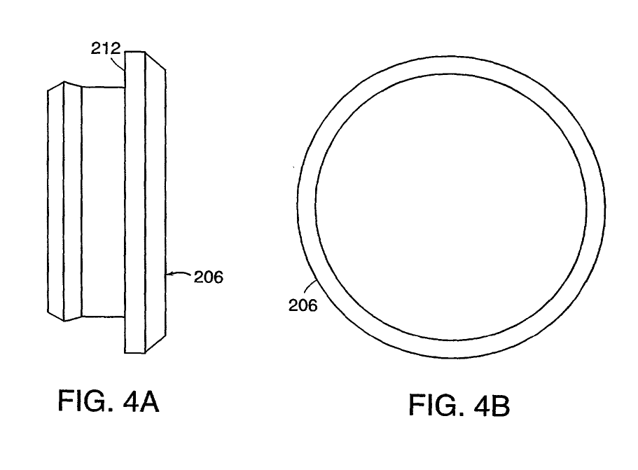

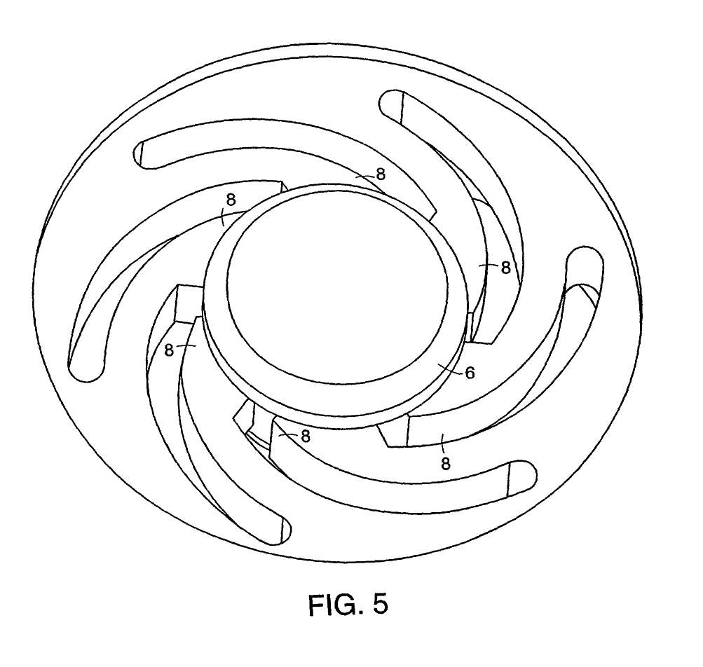

FIGS. 4A and 4B illustrate a top and side view another double tapered pad 206 configured similarly to pad 106, however with a larger diameter flange 212.

The pad 6 can be made from a variety of materials. Desirable characteristics include low vapor pressure at temperature, high hardness, and inertness. Typical materials include metals such as stainless steel, crystals such as quartz, ruby, and sapphire, and ceramics such as silicon carbide, silicon nitride, and tungsten carbide. Because some of these materials are rather brittle and difficult to machine, cylindrically shaped pins of the correct axial length can be advantageously used in accordance with the invention. Alternatively, perfluoroelastomer materials, such as Kalrez®, available from DuPont of Wilimgton, Del., can be used. These materials exhibit a relatively high coefficient of friction and better “grip” the wafer during acceleration and deceleration of the end effector by the robot, protecting against slippage.

The invention, in various embodiments, offers distinct advantages over current end effector designs and manufacturing methods. For example, any pad material can be used with any end effector material, simply by correctly configuring the geometry of the elastic beams 8 and the pad retention area 4. One pad retention area 4 geometry can be used to suit pads from all materials currently used or contemplated for wafer processing applications. Pad installation can be accomplished quickly and easily, without the need for specialized tools or retention techniques. Moreover, pads can be removed easily and damaged pads can easily be replaced. The pad/end effector interface does not have any enclosed areas that can trap debris or contaminants which cannot be cleaned after the pads are installed. Additionally, designs according to the invention do not suffer from problems due to thermal cycling that tend to loosen other conventional retaining mechanisms and eventually cause them to fail. The pad is always under a positive clamping load, holding the pad in place, as long as the end effector is made of material that performs well in the operating environment for processing wafers.

FIG. 5 illustrates a perspective view of a tapered pad 6 installed between elastic beams 8 forming a spiral pattern with a center pad retention area.

FIG. 6A illustrates a top view of three pads 6 installed in an end effector 2, each pad 6 adjacent to an elastic beam 8 forming a pad retention area.

FIG. 6B illustrates a top view of three pads 6 installed in an end effector 202, each pad nested between a pair of elastic beams 8 forming a pad retention area.

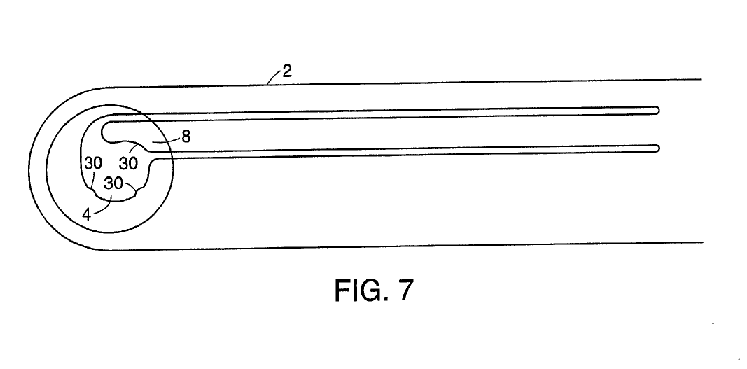

FIG. 7 is a top view of an elastic beam 8 forming a pad retention area 4 in an end effector 2 illustrating a three point contact 30 and bottom flange for retaining a pad in the pad retention area 4.

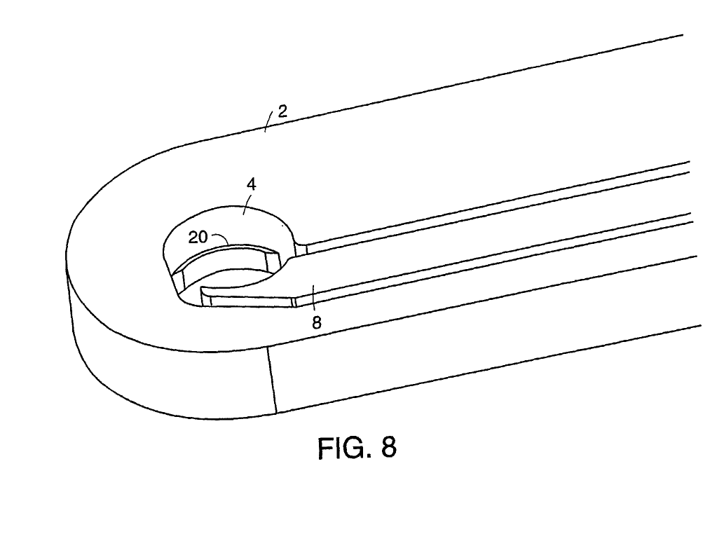

FIG. 8 is a top perspective view of an elastic beam 8 forming a pad retention area 4 in an end effector 2, illustrating a bottom flange 20 for axially supporting the pad 6 at a predetermined height. The flange 20 allows the pad to be installed and positively supported, both radially and axially, thereby preventing the pad from being installed at an improper height or from drifting axially during use.

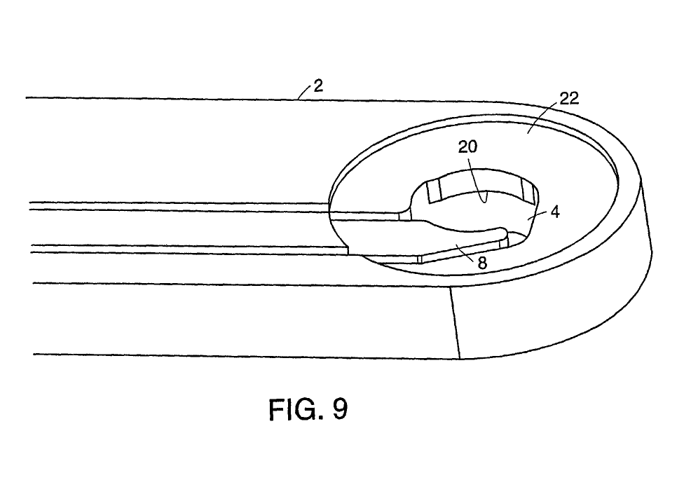

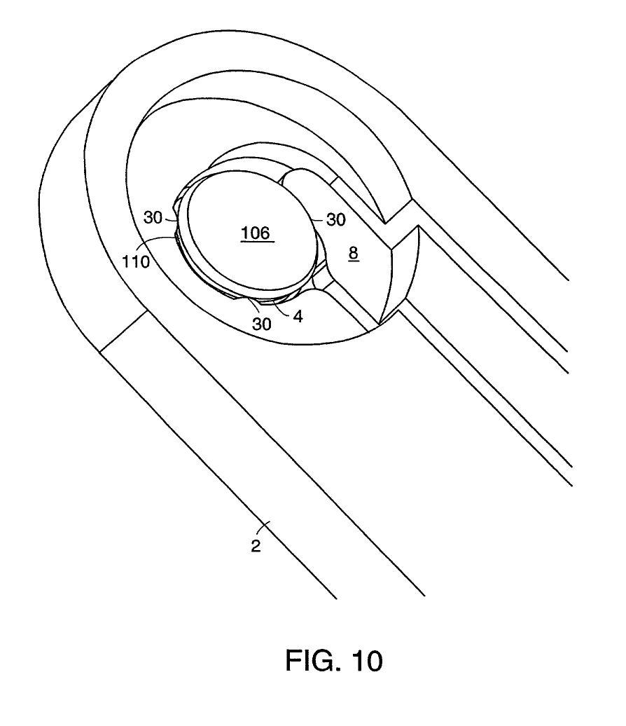

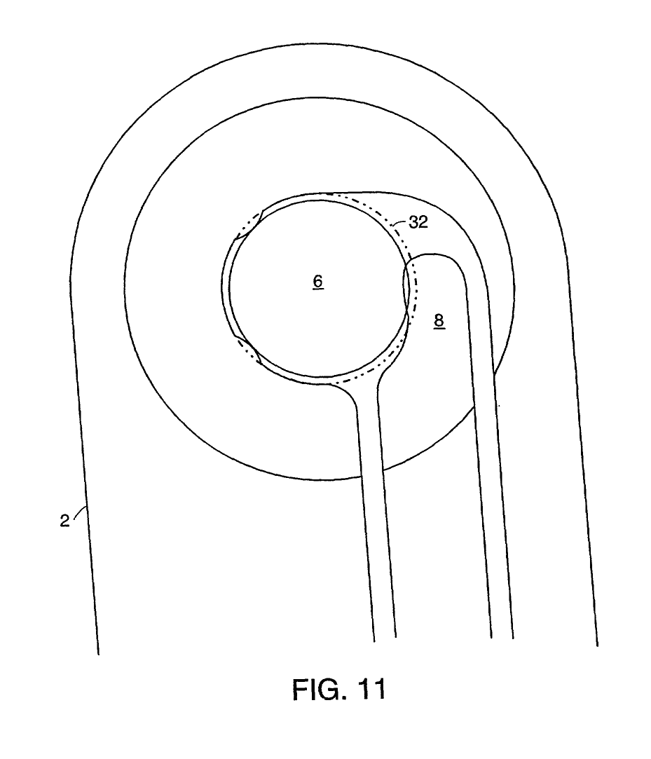

FIG. 9 is bottom perspective view of the elastic beam 8 forming a pad retention area 4 in the end effector 2 shown in FIG. 8, which includes a bottom counterbore 22.

FIG. 10 is a bottom perspective view of a double tapered pad 106 installed proximate an elastic beam 8 in an end effector 2 which illustrates three point contact 30 on the upper tapered pad surface 110 for pulling the pad 106 into the pad retention area 4.

FIG. 11 is a top view of an elastic beam 8 forming a pad retention area 4 in an end effector 2, which illustrates an interference fit 32 of a pad 6 when installed.

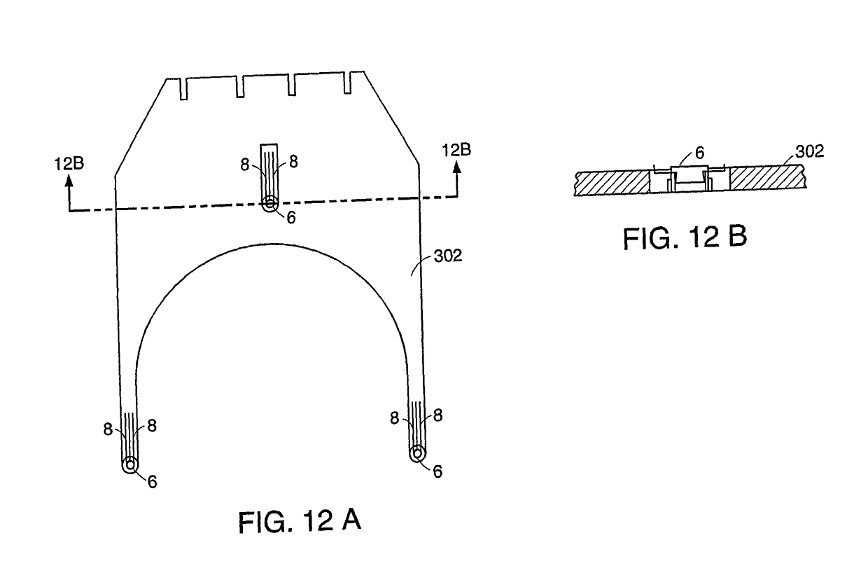

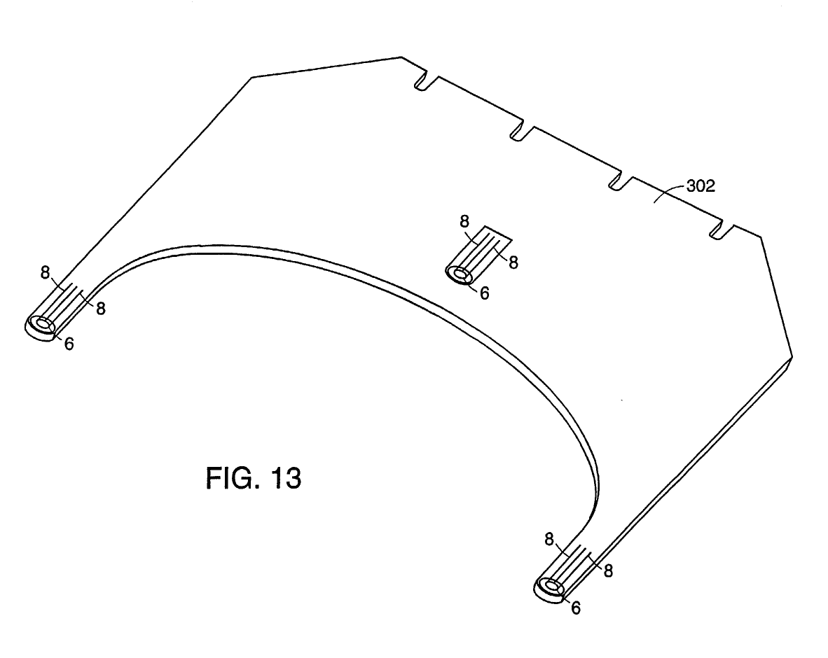

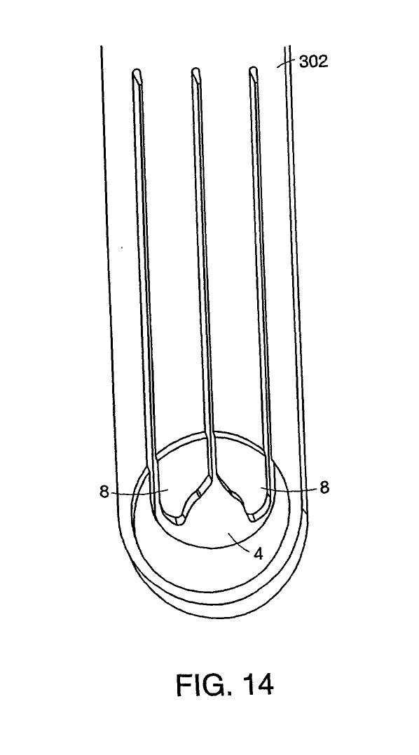

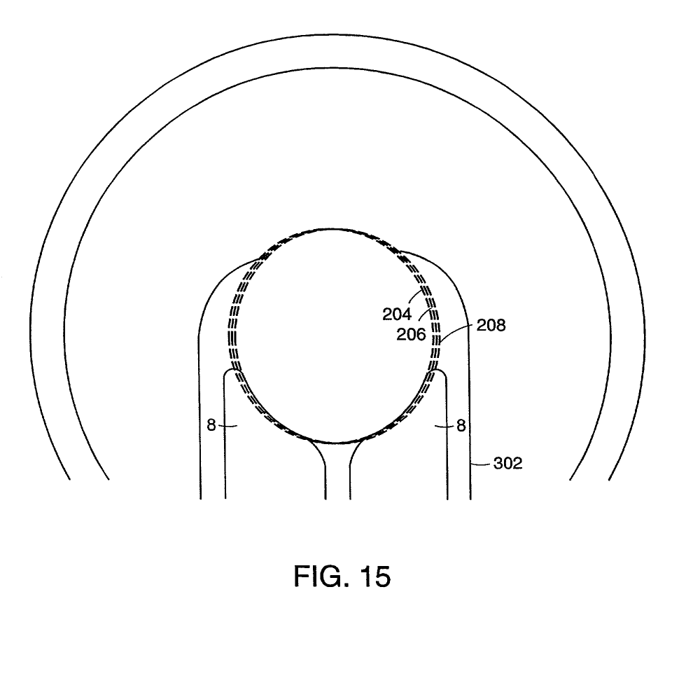

FIG. 12A is a top view of an alternative configuration end effector 302 having three tapered pads 6, each installed between a pair of elastic beams 8 forming a center aperture or a pad retention area therebetween. FIG. 12B is an enlarged cross-sectional view of a detail of the dual beam end effector 302 of FIG. 12A taken along line A-A detailing a fully tapered installed pad with a partially recessed top flange in a counterbore in the end effector 302. FIG. 13 is a perspective view of the end effector 302 of FIG. 12A. FIG. 14 is an enlarged detail view of a tip of the end effector 302 of FIG. 12A without a pad installed. FIG. 15 is an enlarged detail view of the tip of the end effector 302 in FIG. 12A depicting minimum 204, nominal 206, and maximum 208 pad diameters accommodated.

According to the invention, the end effectors can be made relatively thin, on the order of about 0.1 inches in thickness to accommodate high density semiconductor wafer storage cassettes. The end effectors can be sized to support and transport any size wafer, such as conventional 300 mm, 600 mm, and 900 mm diameter wafers. Also, the end effectors according to the invention are relatively light, minimizing the cantilever loading and resultant sagging or deflection of the robotic arm when fully extended to retrieve or replace a wafer in a storage cassette or carousel. Accordingly, the end effector can be accurately positioned and mishandling of wafers is minimized.

While there have been described several embodiments of the invention, other variants and alternatives will be obvious to those skilled in the art. Accordingly, the scope of the invention is not limited to the specific embodiments shown, but rather should be construed from the claims, including all equivalents.

1. An end effector for supporting thin media, the end effector comprising an elastic beam disposed proximate a pad retention area to retain a pad with an elastic interference fit.

2. The invention according to claim 1 wherein the pad retention area forms an aperture.

3. The invention according to claim 2 wherein the pad retention area further forms a counterbore.

4. The invention according to claim 1 wherein the elastic beam has a cross-sectional area which varies along a length thereof.

5. The invention according to claim 1 wherein the elastic beam is configured so that when deflected due to an installed pad, elastic deformation loading in the elastic beam is less than yield strength of the elastic beam.

6. The invention according to claim 1 wherein the elastic beam is configured so that when deflected due to an installed pad, elastic deformation loading in the elastic beam is less than yield strength of the elastic beam at operational temperatures of up to about 750° C.

7. The invention according to claim 1 wherein a shape of the elastic beam is selected from the group consisting of generally linear, generally arcuate, and combinations thereof.

8. The invention according to claim 1 wherein the material for the elastic beam is selected from the group consisting of stainless steel, aluminum, titanium, molybdenum, ceramics, composites, and combinations thereof.

9. The invention according to claim 1 wherein the elastic beam contacts an installed pad along a portion of a circumference thereof.

10. The invention according to claim 1 further comprising a pad installed in the pad retention area, wherein a media contacting surface of the installed pad is above the end effector.

11. The invention according to claim 10 wherein the pad comprises a flange.

12. The invention according to claim 10 wherein the pad comprises a first tapered section.

13. The invention according to claim 10 wherein the pad comprises a double tapered section.

14. The invention according to claim 1 wherein a material for the pad is selected from the group consisting of stainless steel, quartz, ruby, sapphire, silicon carbide, silicon nitride, polymer materials, and tungsten carbide.

15. The invention according to claim 1 further comprising a second elastic beam disposed proximate a second pad retention area to retain a second pad with an elastic interference fit.

16. The invention according to claim 15 further comprising a second pad installed in the second pad retention area.

17. The invention according to claim 15 further comprising a third elastic beam disposed proximate a third pad retention area to retain a third pad with an elastic interference fit.

18. The invention according to claim 17 further comprising a third pad installed in the third pad retention area.

19. The invention according to claim 1 wherein the elastic beam is formed in the end effector using a method selected from the group consisting of wire EDM, water jet, laser, milling, and drilling.

20. A pad for supporting a thin media, the pad comprising a first tapered section and a media contacting surface.

21. The invention according to claim 20 wherein the first tapered section comprises a taper angle with a range from about 0 degrees to about 45 degrees.

22. The invention according to claim 20 wherein the first tapered section comprises a taper angle with a range from about 10 degrees to about 30 degrees.

23. The invention according to claim 20 wherein the first tapered section comprises a taper angle of about 20 degrees.

24. The invention according to claim 20 wherein the first tapered section further comprises a lead in contour.

25. The invention according to claim 20 wherein the first tapered section further comprises a maximum diameter portion disposed remotely from the media contacting surface and a minimum diameter portion disposed therebetween.

26. The invention according to claim 20 wherein the first tapered section is a lead in contour of a double tapered section.
